(19) United States
(12) Patent Application Publication
(10) Pub. No.: US 2015/0358138 A1
(43) Pub. Date: Dec. 10, 2015

(54) Physical Resource Allocation for UL Control Channels in Adaptive TDD Systems

(71) Applicant: MEDIATEK INC., Hsin-Chu, Taiwan (CN)

(72) Inventors: Chien-Hwa HWANG, Zhubei City, Hsinchu County (TW); Min WU, Beijing (CN); Shiang-Jiun LIN, Hsinchu City (TW); Xiangyang ZHUANG, Lake Zurich, IL (US)

(21) Appl. No.: 14/761,122

(22) PCT Filed: Aug. 9, 2013
(86) PCT No.: PCT/CN2013/081194

§ 371 Date: Jul. 15, 2015

(51) Int. Cl. H04L 5/00; H04W 74/00; H04L 1/18

(52) U.S. Cl. CPC H04L 5/0055; H04L 5/0048; H04L 1/1812; H04W 74/004; H04W 74/006

(57) ABSTRACT

The embodiments of this invention propose methods of physical resource allocation for UL control channels including PUCCH and PRACH in adaptive TDD systems. In an adaptive TDD system, there are multiple types of UL-DL configuration, e.g. System configuration, UL-reference configuration (same to System configuration), DL-reference configuration (different from System configuration) and actual configuration. If legacy UE and eIMTA UE respectively follow System configuration and DL-reference configuration to feedback DL HARQ-ACK and corresponding PUCCH resources are implicitly determined by CCE index, PUCCH resource collision may happen, i.e. multiple PUCCHs are transmitted in single resource. The problem of PUCCH resource collision will cause PUCCH performance degeneration and needs to be resolved. Some solutions are proposed in the invention to resolve this problem.

### CROSS REFERENCE TO RELATED APPLICATIONS

The present application is a National Stage Application of PCT Application Ser. No. PCT/CN2013/081194, filed on Aug. 9, 2013. The priority application is hereby incorporated by reference in its entirety.

### FIELD OF INVENTION

The disclosed embodiments relate generally to adaptive TDD network, and, more particularly, to physical resource allocation for UL control channels in adaptive TDD systems.

### BACKGROUND OF THE INVENTION

3GPP system, such as LTE-Advanced (LTE-A) improves spectrum efficiency by utilizing a diverse set of base stations deployed in a heterogeneous network topology. Using a mixture of macro, pico, femto and relay base stations, heterogeneous networks enable flexible and low-cost deployments and provide a uniform broadband user experience.

In recent 3GPP works, the trend of the system design shows the requirements on more flexible configuration of the network system. Based on the system load, traffic type, traffic pattern and so on, the system can dynamically adjust its parameters to further utilize the radio resource and to save the energy. One example is the support of adaptive TDD configuration, where the TDD configuration in the system may adaptively change according to the DL-UL traffic ratio. When the change better matches the instantaneous traffic situation, the system throughput will be enhanced.

In an adaptive TDD system, there are multiple types of UL-DL configuration, e.g. System configuration, UL-reference configuration (same to System configuration), DL-reference configuration (different from System configuration) and actual configuration. If legacy UE and eIMTA (enhancement on Interference Mitigation and Traffic Adaption) UE respectively follow System configuration and DL-reference configuration to feedback DL HARQ-ACK and corresponding PUCCH resources are implicitly determined by CCE index, PUCCH resource collision may happen, i.e. multiple PUCCHs are transmitted in single resource. The problem of PUCCH resource collision will cause PUCCH performance degeneration and needs to be resolved.

In addition, in order to avoid the case that legacy UE transmits PRACH in flexible subframe where actual transmission direction happens to be DL, the PRACH resource shall be restricted in fixed UL resources, i.e. UL subframe #2 and UpPTS in the first special subframe. It is very difficult to restrict PRACH in fixed UL resources, e.g. it is impossible to restrict PRACH resources only in UL subframe #2. This restriction may impact capacity of available PRACH resources and cause larger probability of PRACH preamble collision. As eIMTA UE has the ability to know actual transmission direction of flexible subframe and actual configuration, additional, wherein the ‘eIMTA UE’ means the UE with the ability to support adaptive TDD systems, i.e. eIMTA feature, PRACH resources may be exploited if eIMTA UE can transmit PRACH in flexible subframe. Some enhancements are proposed in the invention for PRACH resource allocation of eIMTA UE.

### SUMMARY OF THE INVENTION

Methods of physical resource allocation for UL control channels including PUCCH and PRACH in adaptive TDD systems are proposed in this invention. To resolve the problem of PUCCH resource collision between legacy UE following System configuration and eIMTA UE following DL-reference configuration which is different from System configuration, five solutions are proposed. In solution 1, the PUCCH resource of eIMTA UE shall be implicitly determined by CCE index and modified DL association set of DL-reference configuration. Re-ordering association index and/or adding virtual index can be used to modify DL association set in some UL subframe(s) where PUCCH resource collision may happen. In solution 2, the PUCCH resource of eIMTA UE shall be explicitly allocated. Multiple PUCCH resources values shall be configured by higher layers and one of these resources is dynamically selected via PHY signaling, e.g. TPC command for PUCCH in a PDCCH assignment or HARQ-ACK resource offset in EPDCCH assignment. In solution 3 and 4, partially implicit and partially explicit resource allocation is used for PUCCH of eIMTA UE and dependent on adjacent corresponding DL association index. In solution 3, if the order of the adjacent corresponding DL association index in DL association set of DL-reference configuration is less than the size of the DL association set of System configuration, PUCCH resource shall be explicitly configured by higher layers. Otherwise, PUCCH resource is determined by CCE index and DL association set of DL-reference configuration. In solution 4, if the adjacent corresponding DL association index is included in DL association set of System configuration, PUCCH resource shall be explicitly configured by higher layers. Otherwise, PUCCH resource is determined by CCE index and DL association set of System configuration. In solution 5, the PUCCH resource of eIMTA UE shall be implicitly determined by CCE index and a DL association set derived based on DL-reference configuration. If actual configuration is not successfully obtained, PUCCH is dropped.

For PRACH resource allocation of eIMTA UE in adaptive TDD systems, three solutions are proposed. In solution 1, the PRACH resource shall be determined by PRACH configuration index under System configuration, and in one example only PRACH resource in available UL subframe or UpPTS can be used. In solution 2, the PRACH resource shall be determined by PRACH configuration index under DL-reference configuration, thus PRACH can be transmitted only in fixed UL subframe or UpPTS of the first special subframe. In solution 3, if PRACH is triggered by UE or is triggered by eNB via RRC signaling, the PRACH resource shall be determined by PRACH configuration index under System configuration or DL-reference configuration. If PRACH is triggered by eNB via PDCCH order signaling, the PRACH resource shall be determined by PRACH configuration index under actual configuration. If configuration is updated, PRACH procedure is early terminated, or only available PRACH resource in updated configuration can be used, or updated PRACH resource is determined by PRACH configuration index under updated configuration. If actual configuration is not successfully obtained, PRACH is dropped or transmitted with contention-based mechanism similar to PRACH triggered by UE.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a mobile communication network utilizing an enhanced physical downlink control channel in accordance with one novel aspect.

FIG. 2 illustrates simplified block diagrams of a base station and a user equipment in accordance with embodiments of the present invention.

FIG. 3 illustrates an scenario of PUCCH resource collision according to an embodiment of this invention.

### DETAILED DESCRIPTION

Reference will now be made in detail to some embodiments of the invention.

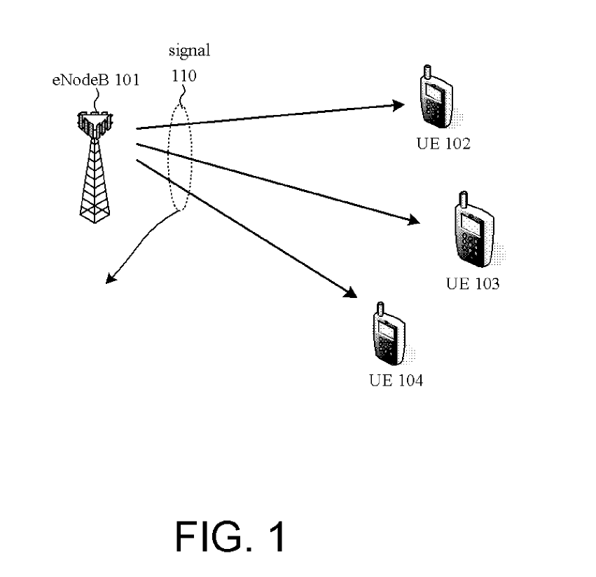

FIG. 1 illustrates a mobile communication network 100 in accordance with one novel aspect. Mobile communication network 100 is an OFDM/OFDMA system comprising a base station eNodeB 101 and a plurality of user equipment UE 102, UE 103, and UE 104. When there is a downlink packet to be sent from eNodeB to UE, each UE gets a downlink assignment, e.g., a set of radio resources in a physical downlink shared channel (PDSCH). When a UE needs to send a packet to eNodeB in the uplink, the UE gets a grant from the eNodeB that assigns a physical downlink uplink shared channel (PUSCH) consisting of a set of uplink radio resources. The UE gets the downlink or uplink scheduling information from a physical downlink control channel (PDCCH) that is targeted specifically to that UE. In addition, broadcast control information is also sent in PDCCH to all UEs in a cell. The downlink or uplink scheduling information and the broadcast control information, carried by PDCCH, is referred to as downlink control information (DCI).

In the example of FIG. 1, in 3GPP LTE system based on OFDMA downlink, the radio resource is partitioned into subframes, each of which is comprised of two slots and each slot has seven OFDMA symbols along time domain. Each OFDMA symbol further consists of a number of OFDMA subcarriers along frequency domain depending on the system bandwidth. The basic unit of the resource grid is called Resource Element (RE), which spans an OFDMA subcarrier over one OFDMA symbol. A physical resource block (PRB) occupies one slot and twelve subcarriers, while a PRB pair occupies two consecutive slots. In one novel aspect.

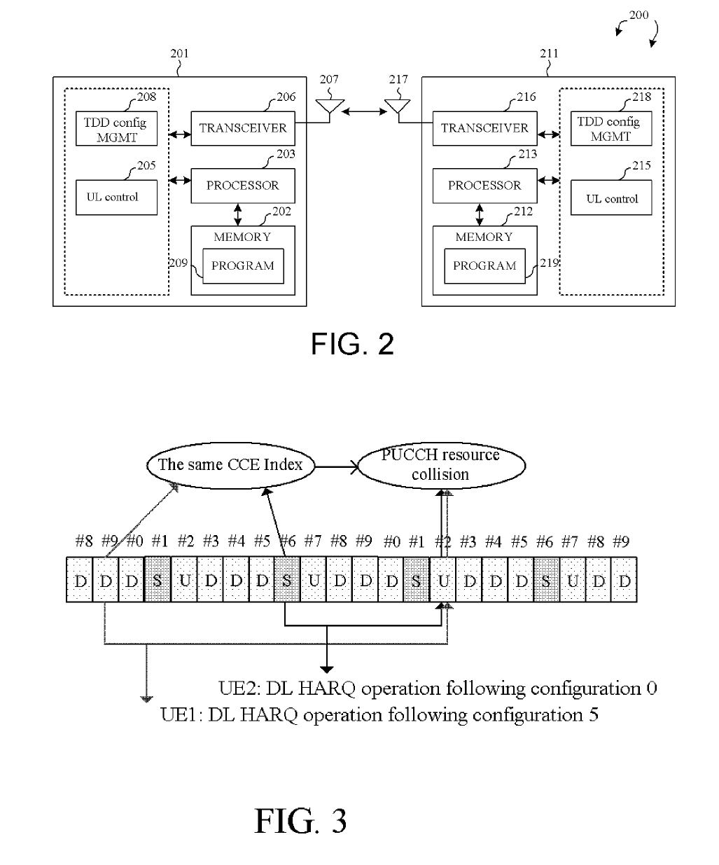

FIG. 2 illustrates simplified block diagrams of a base station 201 and a user equipment 211 in accordance with embodiments of the present invention. For base station 201, antenna 207 transmits and receives radio signals. RF transceiver module 206, coupled with the antenna, receives RF signals from the antenna, converts them to baseband signals and sends them to processor 203. RF transceiver 206 also converts received baseband signals from the processor, converts them to RF signals, and sends out to antenna 207. Processor 203 processes the received baseband signals and invokes different functional modules to perform features in base station 201. Memory 202 stores program instructions and data 209 to control the operations of the base station.

Similar configuration exists in UE 211 where antenna 217 transmits and receives RF signals. RF transceiver module 216, coupled with the antenna, receives RF signals from the antenna, converts them to baseband signals and sends them to processor 213. The RF transceiver 216 also converts received baseband signals from the processor, converts them to RF signals, and sends out to antenna 217. Processor 213 processes the received baseband signals and invokes different functional modules to perform features in UE 211. Memory 212 stores program instructions and data 219 to control the operations of the UE.

The base station 201 and UE 211 also include several functional modules to carry out some embodiments of the present invention. The different functional modules can be implemented by software, firmware, hardware, or any combination thereof. The function modules, when executed by the processors 203 and 213 (e.g., via executing program codes 209 and 219), for example, allow base station 201 to encode and transmit downlink control information to UE 211, and allow UE 211 to receive and decode the downlink control information accordingly. UE also comprises various function modules including a TDD configuration management module 208 that performs actual and/or reference TDD configurations, UL control channel management module 205 that performs UL control channel related operations including generating UL control information, determining physical resource for the UL control channel and so on. Similarly, the eNB also comprises various function modules including a TDD configuration management module 218 that configures actual and/or reference TDD configurations to UE, UL control channel management module 215 that performs UL control channel related operations including generating UL control information, determining physical resource for the UL control channel and so on.

Adaptive TDD Systems

TDD offers flexible deployments without requiring a pair of spectrum resources. Currently, LTE TDD allows asymmetric UL-DL allocations by providing seven different semi-statically configured uplink-downlink configurations. The UL-DL configuration is indicated in system information block 1 and is called as System configuration in the embodiments of this invention. Table 1 illustrates the TDD mode uplink-downlink configurations in an LTE/LTE-A system.

TABLE 1
TDD uplink-downlink configurations

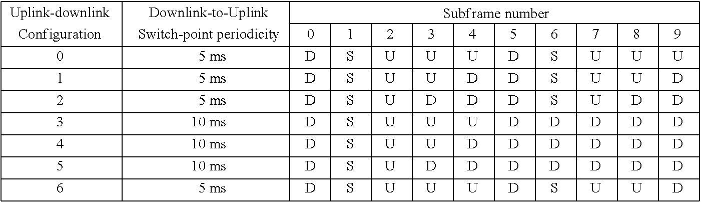

Each radio frame contains ten subframes, D indicates a DL subframe, U indicates an UL subframe, and S indicates a Special subframe/Switch point (SP). Each SP contains a DwPTS (Downlink pilot time slot), a GP (Guard Period), and an UpPTS (Uplink pilot time slot). DwPTS is used for normal downlink transmission and UpPTS is used for uplink channel sounding and random access. DwPTS and UpPTS are separated by GP, which is used for switching from DL to UL transmission. The length of GP needs to be large enough to allow the UE to switch to the timing advanced uplink transmission. These allocations can provide 40% to 90% DL subframe.

Comparing with FDD systems, one advantage of TDD systems is to offer the ability to adjust the ratio of the UL/DL resource to meet traffic request. As the ratio of UL/DL traffic dynamically varies especially in the cell serving a small number of UEs, a suitable UL-DL configuration shall be dynamically configured to match with the traffic status to improve frequency efficiency, i.e. the ratio of configured UL/DL resources shall be close to the ratio of UL/DL traffic. This TDD system with dynamical UL-DL reconfiguration based on traffic status is called as adaptive TDD system. In adaptive TDD systems, subframe can be divided into two types, i.e. fixed subframe with no color and flexible subframe with slashed shadow in table 1. Transmission direction of flexible subframe can dynamically change.

In 3GPP meeting, a Rel-12 WID on e-IMTA (enhancement on Interference Mitigation and Traffic Adaption) is actively discussed. Traffic adaptation may cause inter-cell cross-link interference (i.e. eNB-to-eNB interference and UE-to-UE interference), so corresponding interference mitigations are required. In this invention, ‘eIMTA UE’ means the UE with the ability to support adaptive TDD systems, i.e. eIMTA feature, and PUCCH and PRACH resource allocation of eIMTA UE is just discussed. ‘legacy UE’ means the UE without the ability to support adaptive TDD systems.

In existing specification, legacy UE always performs measurements in every DL subframe. If legacy UE performs DL measurement in a flexible subframe where actual transmission direction happens to be UL, measurement result will be seriously impacted. So System configuration shall be with the least DL subframe(s) to avoid DL measurement issue of legacy UE. In adaptive TDD systems, if HARQ-ACK timing follows actual UL-DL configuration, HARQ-ACK may be missed or dropped due to the fact that actual transmission direction of one flexible subframe used to transmit HARQ-ACK may change and different from expected one. So, semi-static configuration shall be used as reference configuration followed by eIMTA UE to perform HARQ operation, i.e. UL-reference configuration used for UL HARQ and DL-reference configuration used for DL HARQ.

UL-reference shall be with the most schedulable UL subframes, i.e. System configuration. DL-reference configuration shall be with the most schedulable DL subframe. Since DL subframe under System configuration (i.e. UL-reference configuration) and UL subframe under DL-reference configuration are fixed, the set of flexible subframes and the set of candidate actual configurations are determined. If System configuration is same to DL-reference configuration, the number of candidate actual configurations is only one and this means eIMTA feature is disabled. So we just consider the case DL subframe under DL-reference configuration is a superset of DL subframe under System configuration.

System configuration shall be signaled in SIB 1. DL-reference configuration shall be explicitly signaled via dedicated signaling, or implicitly derived via the set of candidate actual configurations configured by higher layers. Actual configuration shall be explicitly signaled via dedicated signaling, or implicitly derived via UL/DL assignment in all flexible subframes.

PUCCH Resource in LTE

In current specification, PUCCH format 1, 1b or 1b with channel selection is used to carry DL HARQ-ACK, and corresponding PUCCH resource is implicitly determined by the first CCE index used for transmission of adjacent DCI (Downlink Control Information) assignment.

In FDD systems, the PUCCH in subframe n is used to carry the HARQ-ACK corresponding to only one PDSCH or PDCCH indicating downlink SPS release in subframe n-4. The PUCCH resource is determined by the first CCE index of the corresponding PDCCH as following:

n_{PUCCH}^{(1,\tilde{p}}^{₀}⁾=n_{CCE}+N_{PUCCH}⁽¹⁾ for antenna port p₀ (Equ.1)

n_{PUCCH}^{(1,\tilde{p}}^{₁}⁾=n_{CCE}+1+N_{PUCCH}⁽¹⁾ for antenna port p₁ (Equ.2)

Here, n_{CCE} is the number of the first CCE (i.e. lowest CCE index used to construct the PDCCH) and N_{PUCCH}⁽¹⁾ is configured by higher layers and cell-specific, wherein cell-specific means the same N_{PUCCH}⁽¹⁾ for all of the served UEs in a cell.

In TDD systems, the PUCCH in subframe n may be used to carry the HARQ-ACK corresponding to multiple DL subframe, i.e. subframe n-kₘ, where kₘ ∈ K and K (defined in Table 2) is a set with M elements {k₀,k₁, . . . k_{M-1}} depending on the subframe n and the UL-DL configuration (defined in Table 1). The PUCCH resource shall be determined by the first CCE index of the adjacent corresponding PDCCH as following:

n_{PUCCH}^{(1,\tilde{p}}^{₀}⁾=(M−m−1)·N_{c}+m·N_{c+1}+n_{CCE}+N_{PUCCH}⁽¹⁾ for antenna port p₀ (Equ.3)

n_{PUCCH}^{(1,\tilde{p}}^{₁}⁾=(M−m−1)·N_{c}+m·N_{c+1}+n_{CCE}+1+N_{PUCCH}⁽¹⁾ for antenna port p₁ (Equ. 4)

Wherein, V_{PUCCH}⁽¹⁾ is configured by higher layers, N_{c}=max{0, └[N_{RB}^{DL}·(N_{sc}^{RB}·c−4)]/36┘}, and n_{CCE} is the number of the first CCE used for transmission of the corresponding PDCCH in subframe n-kₘ and the corresponding m. And kₘ is the smallest value in set K such that UE detects a PDCCH indicating PDSCH transmission or downlink SPS release in subframe(s) n-kₘ and kₘ ∈ K. A c value is selected out of {0, 1, 2, 3} to make N_{c}≦n_{CCE}<N_{c+1}.

TABLE 2
Downlink association index set K: {k₀, k₁, . . . k_{M-1}} for TDD systems

| UL/DL | Subframe n | | | | | | | | | |
|---|---|---|---|---|---|---|---|---|---|---|
| Configuration | 0 | 1 | 2 | 3 | 4 | 5 | 6 | 7 | 8 | 9 |
| 0 | — | — | 6 | — | 4 | — | — | 6 | — | 4 |
| 1 | — | — | 7, 6 | 4 | — | — | — | 7, 6 | 4 | — |
| 2 | — | — | 8, 7, 4, 6 | — | — | — | — | 8, 7, 4, 6 | — | — |
| 3 | — | — | 7, 6, 11 | 6, 5 | 5, 4 | — | — | — | — | — |
| 4 | — | — | 12, 8, 7, 11 | 6, 5, 4, 7 | — | — | — | — | — | — |
| 5 | — | — | 13, 12, 9, 8, | — | — | — | — | — | — | — |
| | | | 7, 5, 4, 11, | | | | | | | |
| | | | 6 | | | | | | | |
| 6 | — | — | 7 | 7 | 5 | — | — | 7 | 7 | — |

According to equation 1˜4, multiple PUCCH resources are implicitly reserved based on the number of CCE in the associated DL subframe. Comparing with FDD systems, the number of reserved PUCCH resources in TDD systems is much more since the number of CCE is accumulated across all associated DL subframe in set K. For example, the number of reserved PUCCH resources in subframe #2 in UL-DL configuration #5 is about 9 times that in FDD systems as the associated DL subframe set K includes 9 elements. However, the actually used number of PUCCH resources is determined by the number of simultaneously served UE during the associated DL subframe(s). A lot of reserved PUCCH resources will cause resource reduction of PDSCH for data transmission and resource waste if the number of simultaneously served UE is relatively small.

In addition, the PUCCH resource is dependent on the UL-DL configuration used to determine HARQ-ACK timing. If eNB and UE have different understanding on UL-DL configuration, PUCCH detection is very difficult since eNB and UE have different understanding on HARQ-ACK timing and corresponding PUCCH resources. If two UEs have different understanding of UL-DL configuration, PUCCH resource collision may happen.

FIG. 3 illustrats an scenario of PUCCH resource collision according to an embodiment of this invention. In FIG. 3, two UEs follow different configurations to perform DL HARQ operation. Assume UE1 (eIMTA UE) follows configuration 5 (DL-reference configuration), and UE2 (legacy UE) follows configuration 2 (System configuration), and actual UL-DL configuration is configuration 2. Assume CCE index n_{CCE} used to determine the PUCCH resource is same for UE1 and UE2 respectively in subframe #9 and #6, and c=0 is selected to meet 0≦n_{CCE}<└N_{RB}^{DL}/4┘. Due to m=0 and N₀=0, PUCCH resources of the two UEs is same PUCCH resource collision will happen in subframe #2, i.e. the two UEs transmit their PUCCH with the same resource.

PRACH Resource in LTE

In existing specification, PRACH is mainly divided into two types, i.e. contention-based PRACH triggered by UE and non-contention-based PRACH triggered by eNB. Regarding the two types of PRACH, corresponding purpose and mechanism may be different.

If PRACH is triggered by UE, the purpose may be to initiate RRC connection request from RRC_IDLE mode to RRC_CONNECTED mode, request the PUSCH resource when UL data arriving and no available SR (Scheduling Request) resource in RRC_CONNECTED mode, or request re-establishment of a radio link when RLF (Radio Link Failure) occurs in RRC_CONNECTED mode. The type of PRACH is contention-based and includes Message 3 and Message 4 used for contention resolution. One PRACH preamble is randomly selected and transmitted in anyone of configured PRACH resources based on PRACH configuration in SIB 2, e.g. root sequence index, PRACH configuration index and so on. Regarding the type of PRACH, PRACH preamble collision may happen since corresponding PRACH preamble is common.

If PRACH is triggered by eNB, the purpose may be to obtain the required UL timing advance value for UL timing synchronization in RRC_CONNECTED mode, or establish UL timing synchronization to target eNB during handover procedure. The type of PRACH is non-contention-based and doesn't include MSG3 and MSG4. Corresponding PRACH preamble and resource are explicitly signaled by the eNB via PDCCH order or RRC signaling. Signaled PRACH mask index indicates one PRACH resource out of configured PRACH resources in a radio frame, or the 1^{st} PRACH resource in the subframe with even/odd PRACH opportunity in time domain. In TDD systems, the PRACH mask index can also indicate one PRACH resource from the first three resources in every available PRACH subframe. Regarding the type of PRACH, PUCCH collision doesn't happen since corresponding PRACH preamble is UE-specific.

There are mostly 10 PRACH resources per 10 ms in FDD systems and 6 PRACH resources in TDD systems. Comparing with FDD systems, the number of PRACH resources in a radio frame is relatively small. Assuming the number of served UE in RRC_IDLE and RRC_CONNECTED mode is same, the probability of PRACH preamble collision in TDD systems is larger than that in FDD systems.

In TDD systems, the PRACH resource is dependent on UL-DL configuration similarly the to PUCCH resource. PRACH configuration index is used to find four resource parameters (∫_{RA},t_{RA}⁽⁰⁾,t_{RA}⁽¹⁾,t_{RA}⁽²⁾) associated with UL-DL configuration to determine the PRACH resource as showed in table 3. Here, ∫_{RA} is the PRACH resource frequency index in the considered time-domain location, and t_{RA}⁽⁰⁾ is radio frame indicator index of PRACH opportunity, and t_{RA}⁽¹⁾ is half frame index of PRACH opportunity in the radio frame, and t_{RA}⁽²⁾ is uplink subframe number for start of PRACH opportunity in the half frame.

TABLE 3
PRACH resource mapping in time and frequency in TDD systems

| PRACH | | | | | | | |
|---|---|---|---|---|---|---|---|
| configuration | UL/DL configuration (See Table 1) | | | | | | |
| Index | 0 | 1 | 2 | 3 | 4 | 5 | 6 |
| 0 | (0, 1, 0, 2) | (0, 1, 0, 1) | (0, 1, 0, 0) | (0, 1, 0, 2) | (0, 1, 0, 1) | (0, 1, 0, 0) | (0, 1, 0, 2) |
| 1 | (0, 2, 0, 2) | (0, 2, 0, 1) | (0, 2, 0, 0) | (0, 2, 0, 2) | (0, 2, 0, 1) | (0, 2, 0, 0) | (0, 2, 0, 2) |
| 2 | (0, 1, 1, 2) | (0, 1, 1, 1) | (0, 1, 1, 0) | (0, 1, 0, 1) | (0, 1, 0, 0) | N/A | (0, 1, 1, 1) |
| 3 | (0, 0, 0, 2) | (0, 0, 0, 1) | (0, 0, 0, 0) | (0, 0, 0, 2) | (0, 0, 0, 1) | (0, 0, 0, 0) | (0, 0, 0, 2) |
| 4 | (0, 0, 1, 2) | (0, 0, 1, 1) | (0, 0, 1, 0) | (0, 0, 0, 1) | (0, 0, 0, 0) | N/A | (0, 0, 1, 1) |
| 5 | (0, 0, 0, 1) | (0, 0, 0, 0) | N/A | (0, 0, 0, 0) | N/A | N/A | (0, 0, 0, 1) |
| 6 | (0, 0, 0, 2) | (0, 0, 0, 1) | (0, 0, 1, 0) | (0, 0, 0, 1) | (0, 0, 0, 0) | (0, 0, 0, 0) | (0, 0, 0, 2) |
| | (0, 0, 1, 2) | (0, 0, 1, 1) | (0, 0, 1, 0) | (0, 0, 0, 2) | (0, 0, 0, 1) | (1, 0, 0, 0) | (0, 0, 1, 1) |
| 7 | (0, 0, 0, 1) | (0, 0, 0, 0) | N/A | (0, 0, 0, 0) | N/A | N/A | (0, 0, 0, 1) |
| | (0, 0, 1, 1) | (0, 0, 1, 0) | | (0, 0, 0, 2) | | | (0, 0, 1, 0) |
| 8 | (0, 0, 0, 0) | N/A | N/A | (0, 0, 0, 0) | N/A | N/A | (0, 0, 0, 0) |
| | (0, 0, 1, 0) | | | (0, 0, 0, 1) | | | (0, 0, 1, 1) |
| . . . | . . . | . . . | . . . | . . . | . . . | . . . | . . . |
| 63 | N/A | N/A | N/A | N/A | N/A | N/A | N/A |

In TDD systems, implicitly allocated PUCCH resource is dependent on UL-DL configuration. In adaptive TDD systems, eIMTA UE shall follow DL-reference configuration to feedback DL HARQ-ACK, and legacy UE shall follow System configuration to feedback DL HARQ-ACK. Considering DL measurement issue of legacy UE, System configuration shall be with the most UL subframes within candidate configurations. To support DL HARQ-ACK report under all candidate configurations, semi-static DL-reference configuration shall be with the most DL subframes within candidate configurations. Due to the two different criterions, DL-reference configurations shall be different from System configuration. So the PUCCH resource collision may happen between eIMTA UE following DL-reference configuration and legacy UE following System configuration. The problem of PUCCH resource collision will cause wrong detection of DL HARQ-ACK and shall be resolved.

Similar to PUCCH resource, the PRACH resource allocation is also dependent on UL-DL configuration. In adaptive TDD systems, there are multiple types of UL-DL configuration, e.g. System configuration, UL-reference configuration, DL-reference configuration and actual configuration. The PRACH resource of eIMTA UE shall be determined by PRACH configuration index under which configuration is a problem. If eIMTA UE is aware of actual transmission direction of a flexible subframe, PRACH may be transmitted in one of the flexible subframes. If eIMTA UE can successfully obtain actual configuration, the PRACH resource may be determined by the PRACH configuration index under actual configuration. If the UL-DL configuration used for PRACH resource allocation of eIMTA UE is different from that of legacy UE, or the UL-DL configuration used for PRACH resource allocation of eIMTA UE when PRACH is triggered by eNB is different from that when PRACH is triggered by UE, in one embodiment, additional PRACH resources can be exploited, and the number of PRACH resources in adaptive TDD systems can be increased to the same with that in FDD systems.

In the following section, several solutions of PUCCH and PRACH the resource allocation for eIMTA UE in adaptive TDD systems are proposed. Several issues and the corresponding solutions are discussed in the following subsections.

Section 1: PUCCH Resource Allocation of eIMTA UE for PUCCH Format 1/1a/1b/1b with CS

Solution 1: PUCCH Resource is Implicitly Determined by CCE Index and Modified DL Association Set of DL-Reference Configuration.

As discussed in previous sections, the first CCE index n_{CCE} used for transmission of adjacent corresponding PDCCH may be same for different UEs in different associated DL subframes, and this will cause the PUCCH resource collision as the two UEs follow different configurations to feedback DL HARQ-ACK. One of the essential reasons is that DL association set K is different under different UL-DL configurations. In table 1, the DL association set in subframe #2 is respectively K:{6} under configuration 0 and K: {13,12,9,8,7,5,4,11,6} under configuration 5. In the two DL association sets, the first DL association index k₀ is different and associated with different DL subframe, i.e. subframe #6 when k₀=6 and subframe #9 when k₀=13. As illustrated in FIG. 1, if the first CCE index used for transmission of adjacent PDCCH corresponding to DL association index k₀, the PUCCH resource collision may happen between legacy UE and eIMTA UE in UL subframe #2.

If one associated DL subframe has the same order m in the DL association set K of different UL-DL configurations, the PUCCH resource collision will not happen even if the first CCE index n_{CCE} used to implicitly determine the PUCCH resource is same for different UEs following different configurations for DL HARQ-ACK feedback. This means re-ordering the DL association index kₘ can avoid the PUCCH resource collision. For example, as DL association set of configuration 0 in UL subframe #2 is K: {6} , corresponding DL association set K: {13,12,9,8,7,5,4,11,6} of configuration 5 shall be re-ordered as K: {6,13,12,9,8,7,5,4,11} to avoid the PUCCH resource collision in UL subframe #2. After re-ordering DL association index, even if the same CCE index n_{CCE} and c=0 is selected, the PUCCH resource is different as the order m is different. By re-ordering DL association index, eIMTA UE and legacy UE can share the PUCCH resources determined by CCE index in the DL subframe associated with re-ordered DL association index.

After re-ordering DL association index, the DL association index corresponding to special subframe may be placed in the front of re-ordered DL association set. In above example, kₘ=6 is moved to front from back of DL association set K:{13,12,9,8,7,5,4,11,6} . Under some special subframe configurations (e.g. 0/5 for normal CP, and 0/4/7 for extended CP), there is only control region and not data region in special subframe, consequently there no any corresponding DL HARQ-ACK in special subframe. In this case, unnecessary reservation of PUCCH resources for DL HARQ-ACK of special subframe will cause resource waste. So UE shall remove the DL association index to reduce the order m and corresponding size M when the case occurs, i.e. corresponding special subframe configurations are configured. Thus, unnecessary reservation of PUCCH resource can be avoided.

In one example, re-ordering DL association index is suitable for the case DL association set of System configuration is a subset of DL association set of DL-reference configuration. For example, DL association set K: {6} of configuration 0 is a subset of DL association set K: {13,12,9,8,7,5, 4,11,6} of configuration 5 in UL subframe #2. If this condition cannot be met, virtual index (VI) is required. Virtual index is used to re-number DL association index and doesn't associate with any DL subframe, and the size M of DL association set will get larger. However, virtual index doesn't impact any other DL HARQ-ACK operations, e.g. HARQ-ACK timing, generation of HARQ-ACK bits and so on, and is just used to adjust the order m and the size M used to determine PUCCH resource based on CCE index. For example, assuming System configuration is 0 and DL-reference configuration is 4, corresponding DL association set in UL subframe #2 is respectively K: {6} and K:{12,8,7,11}, the DL association set of DL-reference configuration shall be modified as K: {VI,12,8,7,11}.

In addition, adding virtual index can be used to replace re-ordering DL association index. For every element in the DL association set of System configuration, a virtual index shall be added in corresponding order regardless of whether the DL association index is included in the DL association set of DL-reference configuration. For example, assuming System configuration is 0 and DL-reference configuration is 5, corresponding DL association set in UL subframe #2 is respectively K: {6} and K: {13,12,9,8,7,5,4,11,6}, the DL association set of DL-reference configuration shall be modified as K: {VI,13,12,9,8,7,5, 4,11, 6}. The difference between adding virtual index and re-ordering DL association index, the PUCCH resources determined by CCE index in the DL subframe associated with the DL association index of System configuration cannot be shared by eIMTA UE and legacy UE. This means more PUCCH resources need to reserve for eIMTA UE.

Embodiment #1: When an eIMTA UE follows a DL-reference configuration different from System configuration and uses PUCCH format 1/1a/1b/1b with CS to feedback DL HARQ-ACK, the eIMTA UE shall determine the PUCCH resource according to modified DL association set index of DL-reference configuration. Re-ordering DL association index and adding virtual index can be used to modify DL association set index of DL-reference configuration, and corresponding modification is dependent on System configuration.

In following table 4˜9, ‘→’ means modifying from K to K′, ‘VI’ means virtual index used for re-numbering DL association index.

Table 4 is an example of Modified downlink association sets. Assuming System configuration is 0, possible DL-reference configurations are 1˜6. Corresponding modified DL association sets K′ are showed in table 4. In following table, some DL association sets needn't to be modified as they doesn't cause the PUCCH resource collision, i.e. without ‘→’. For example, DL association set K: {4} of DL-reference configuration 1 in UL subframe #3 and #8, DL association set K: {6,5} of DL-reference configuration 3 in UL subframe #3 and so on.

TABLE 4
Modified downlink association set K′: {k₀′, k₁′, . . . k_{M-1}′}

| DL-reference | | | | | | | | | | |
|---|---|---|---|---|---|---|---|---|---|---|
| Configu- | Subframe n | | | | | | | | | |
| ration | 0 | 1 | 2 | 3 | 4 | 5 | 6 | 7 | 8 | 9 |
| 1 | — | — | 7, 6→6, 7 | 4 | — | — | — | 7, 6→6, 7 | 4 | — |
| 2 | — | — | 8, 7, 4, 6→6, | — | — | — | — | 8, 7, 4, 6→6, | — | — |
| | | | 8, 7, 4 | | | | | 8, 7, 4 | | |
| 3 | — | — | 7, 6, 11 →6, 7, | 6, 5 | 5, 4→4, 5 | — | — | — | — | — |
| | | | 11 | | | | | | | |
| 4 | — | — | 12, 8, 7, 11→VI, | 6, 5, 4, 7 | — | — | — | — | — | — |
| | | | 12, 8, 7, 11 | | | | | | | |
| 5 | — | — | 13, 12, 9, 8, | — | — | — | — | — | — | — |
| | | | 7, 5, 4, 11, 6 | | | | | | | |
| | | | →6, 13, 12, 9, | | | | | | | |
| | | | 8, 7, 5, 4, 11 | | | | | | | |
| 6 | — | — | 7→ VI, 7 | 7 | 5 | — | — | 7→ VI, 7 | 7 | — |

Table 4 is the second example of Modified downlink association sets. Assuming System configuration is 1, possible DL-reference configurations is 2 and 5. Corresponding modified DL association sets K′ are showed in table 5.

TABLE 5
Modified downlink association set K′: {k₀′, k₁′, . . . k_{M-1}′}

| DL-reference | | | | | | | | | | |
|---|---|---|---|---|---|---|---|---|---|---|
| Configu- | Subframe n | | | | | | | | | |
| ration | 0 | 1 | 2 | 3 | 4 | 5 | 6 | 7 | 8 | 9 |
| 2 | — | — | 8, 7, 4, 6→7, | — | — | — | — | 8, 7, 4, 6→7, | — | — |
| | | | 6, 8, 4 | | | | | 6, 8, 4 | | |
| 5 | — | — | 13, 12, 9, 8, | — | — | — | — | — | — | — |
| | | | 7, 5, 4, 11, | | | | | | | |
| | | | 6→7, 6, 13, 12, | | | | | | | |
| | | | 9, 8, 5, 4, 11 | | | | | | | |

Table 6 is the third example of Modified downlink association sets. Assuming System configuration is 2, possible DL-reference configuration is 5. Corresponding modified DL association set K′ is showed in table 6.

TABLE 6
Modified downlink association set K′: {k₀′, k₁′, . . . k_{M-1}′}

| DL-reference | | | | | | | | | | |
|---|---|---|---|---|---|---|---|---|---|---|
| Configu- | Subframe n | | | | | | | | | |
| ration | 0 | 1 | 2 | 3 | 4 | 5 | 6 | 7 | 8 | 9 |
| 5 | — | — | 13, 12, 9, 8, | — | — | — | — | — | — | — |
| | | | 7, 5, 4, 11, | | | | | | | |
| | | | 6→8, 7, 4, 6, | | | | | | | |
| | | | 13, 12, 9, 5, 11 | | | | | | | |

Table 7 is the fourth example of Modified downlink association sets. Assuming System configuration is 3, possible DL-reference configurations is 4 and 5. Corresponding modified DL association sets K′ are showed in table 7.

TABLE 7
Modified downlink association set K′: {k₀′, k₁′, . . . k_{M-1}′}

| DL-reference | | | | | | | | | | |
|---|---|---|---|---|---|---|---|---|---|---|
| Configu- | Subframe n | | | | | | | | | |
| ration | 0 | 1 | 2 | 3 | 4 | 5 | 6 | 7 | 8 | 9 |
| 4 | — | — | 12, 8, 7, 11→7, | 6, 5, 4, 7 | | | | | | |
| | | | VI, 11, 12, 8 | | | | | | | |
| 5 | — | — | 13, 12, 9, 8, | — | — | — | — | — | — | — |
| | | | 7, 5, 4, 11, | | | | | | | |
| | | | 6→8, 7, 4, 6, | | | | | | | |
| | | | 13, 12, 9, 5, 11 | | | | | | | |

Table 8 is the fifth example of Modified downlink association sets. Assuming System configuration is 4, possible DL-reference configuration is 5. Corresponding modified DL association set K′ is showed in table 8.

TABLE 8
Modified downlink association set K′: {k₀′, k₁′, . . . k_{M-1}′}

| DL-reference | | | | | | | | | | |
|---|---|---|---|---|---|---|---|---|---|---|
| Configu- | Subframe n | | | | | | | | | |
| ration | 0 | 1 | 2 | 3 | 4 | 5 | 6 | 7 | 8 | 9 |
| 5 | — | — | 13, 12, 9, 8, | — | — | — | — | — | — | — |
| | | | 7, 5, 4, 11, | | | | | | | |
| | | | 6→12, 8, 7, | | | | | | | |
| | | | 11, 13, 9, 5, | | | | | | | |
| | | | 4, 6 | | | | | | | |

Table 9 is the sixth example of Modified downlink association sets. Assuming System configuration is 6, possible DL-reference configuration is 5. Corresponding modified DL association set K′ is showed in table 9.

TABLE 9
Modified downlink association set K′: {k₀′, k₁′, . . . k_{M-1}′}

| DL-reference | | | | | | | | | |
|---|---|---|---|---|---|---|---|---|---|
| Configu- | Subframe n | | | | | | | | |
| ration | 0 | 1 | 2 | 3 | 4 | 5 | 6 | 7 | 8 |
| 5 | — | — | 13, 12, 9, 8, | — | — | — | — | — | — |
| | | | 7, 5, 4, 11, | | | | | | |
| | | | 6→7, 13, 12, 9, | | | | | | |
| | | | 8, 5, 4, 11, 6 | | | | | | |

Solution 2: PUCCH Resource is Explicitly Allocated by Higher Layers.

To resolve the problem of the PUCCH resource collision between eIMTA UE and legacy UE, another solution is to explicitly configure the PUCCH resource for eITMA UE via higher layer signaling and PHY signaling. Multiple PUCCH resource values are configured by higher layers, and one of these PUCCH resource values is indicated via PHY signaling. Since the PUCCH resource is explicitly allocated by eNB, eNB can avoid the PUCCH resource collision between eIMTA UE and legacy UE via resource allocation. In addition, according to the number of simultaneously served UEs, eNB can allocate proper number of PUCCH resources to avoid unnecessary resource waste. The physical resource not reserved for PUCCH can be allocated to PUSCH for data transmission.

Embodiment #2: When an eIMTA UE follows a DL-reference configuration different from System configuration and uses PUCCH format 1/1a/1b/1b with CS to feedback DL HARQ-ACK, the PUCCH resource of the eIMTA UE shall be explicitly allocated. Four PUCCH resource values are configured by higher layers and one of four resource values is indicated via PHY signaling, i.e. the value of ‘TPC command for PUCCH’ in corresponding PDCCH assignment or the value of ‘HARQ-ACK resource offset’ in corresponding EPDCCH assignment as showed in table 10. The UE shall assume that the same PUCCH resource value is transmitted on all PDCCH/EPDCCH assignments. If the PUCCH resource values determined by all PDCCH/EPDCCH assignments are different, the UE shall select the PUCCH resource determined by the adjacent PDCCH/EPDCCH assignment, i.e. kₘ is the smallest value in DL association set K.

TABLE 10
PUCCH Resource Value for DL HARQ-ACK Report

| Value of ‘TPC command for | |
|---|---|
| PUCCH’ or ‘HARQ-ACK | |
| resource offset’ | n_{PUCCH}^{(1,} \tilde{^{p}}⁾ |
| ‘00’ | The 1st PUCCH resource value |
| | configured by the higher layers |
| ‘01’ | The 2^{nd} PUCCH resource value |
| | configured by the higher layers |
| ‘10’ | The 3^{rd} PUCCH resource value |
| | configured by the higher layers |
| ‘11’ | The 4^{th} PUCCH resource value |
| | configured by the higher layers |

Solution 3: One Hybrid Method with Partially Explicit and Partially Implicit Resource Allocation.

In the third solution, partially explicit and partially implicit resource allocation is used for eIMTA UE. Explicit resource allocation is used just for the case PUCCH resource implicitly determined by CCE index may happen resource collision with legacy UE. In the case, DL association index corresponding to adjacent PDCCH/EPDCCH under DL-reference configuration is different from that under System configuration but the order is same, i.e. m is same and kₘ is different. Explicit resource allocation is similar to solution 2, i.e. the value of ‘TPC command for PUCCH’ or ‘HARQ-ACK resource offset’ is used to determine PUCCH resource from one of four resource values configured by higher layers. If PUCCH resource determined implicitly by CCE index doesn't happen resource collision with legacy UE, traditional implicit resource allocation based on CCE index can be reused. In the case, the order of DL association index of DL-reference configuration is different from that of System configuration, i.e. m is different, or is same to that of System configuration and the DL association index is also same, i.e. both m and kₘ are same.

Embodiment #3: When an eIMTA UE follows a DL-reference configuration different from System configuration and uses PUCCH format 1/1a/1b/1b with CS to feedback DL HARQ-ACK, partially implicit and partially explicit resource allocation shall be used for PUCCH of the eIMTA UE. Assuming System configuration is 0, possible DL-reference configurations is 1˜6. If adjacent corresponding PDCCH/EPDCCH assignment is corresponding to the DL association index kₘ with no color as showed in table 11, explicit resource allocation is used, i.e. the value of ‘TPC command for PUCCH’ or ‘HARQ-ACK resource offset’ is used to determine PUCCH resource from one of four resource values configured by higher layers. If adjacent corresponding PDCCH/EPDCCH assignment is associated with the DL association index kₘ with slashed shadow as showed in table 10, implicit resource allocation is used, i.e. PUCCH resource is determined by CCE index.

TABLE 11
Downlink association set K: {k₀, k₁, . . . k_{M-1}}

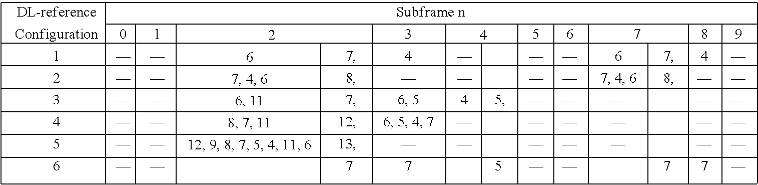

Solution 4: Another Hybrid Method with Partially Explicit and Partially Implicit Resource Allocation.

In the fourth solution, partially explicit and partially implicit resource allocation is used for eIMTA UE. Explicit resource allocation is used just for the case DL association index kₘ of DL-reference configuration is not included in DL association index set K of System configuration. Explicit resource allocation is similar to solution 2, i.e. the value of ‘TPC command for PUCCH’ or ‘HARQ-ACK resource offset’ is used to determine PUCCH resource from one of four resource values configured by higher layers. For other case DL association index kₘ of DL-reference configuration is included in DL association index set K of System configuration, PUCCH resource shall be implicitly determined by CCE index, and the order of the DL association index and corresponding size of DL association set shall follow System configuration. Since the DL association index used to determine PUCCH resource is associated with the same DL subframe for legacy UE and eIMTA UE, it is impossible that corresponding CCE index is same. So PUCCH resource collision doesn't happen. Comparing with solution 3, the number of implicitly reserved PUCCH resources is relatively small and the number of explicitly allocated PUCCH resources is relatively large.

Embodiment #4: When an eIMTA UE follows a DL-reference configuration different from System configuration and uses PUCCH format 1/1a/1b/1b with CS to feedback DL HARQ-ACK, partially implicit and partially explicit resource allocation shall be used for PUCCH of the eIMTA UE. Assuming System configuration is 0, possible DL-reference configurations are 1˜6. If adjacent corresponding PDCCH/EPDCCH assignment is associated with the DL association index kₘ with no color as showed in table 12, explicit resource allocation is used, i.e. the value of ‘TPC command for PUCCH’ or ‘HARQ-ACK resource offset’ is used to determine PUCCH resource from one of four resource values configured by higher layers. If adjacent corresponding PDCCH/EPDCCH assignment is associated with the DL association index kₘ with slashed shadow as showed in table 12, implicit resource allocation is used, i.e. PUCCH resource is determined by CCE index. And the order m of DL association index with slashed shadow and corresponding size M shall follow System configuration. For example in UL subframe #2, when DL association index kₘ=6, the order m and association set size M shall follow DL association set K: {6} of System configuration 0, i.e. m=0, and M=1.

TABLE 12
Downlink association set K: {k₀, k₁, . . . k_{M-1}}

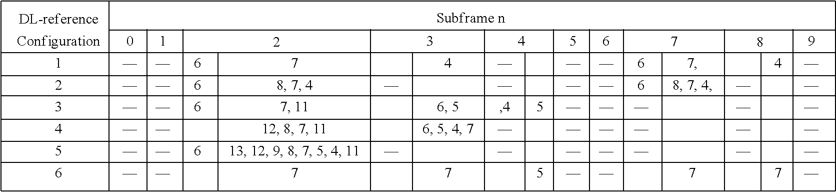

Solution 5: PUCCH Resource is Implicitly Determined by CCE Index and Derived DL Association Based on Actual Configuration.

Actual configuration shall be explicitly signaled or implicitly derived. If a dedicated signaling is used to indicate actual configuration and corresponding CRC check is passed, actual configuration can be obtained. Since UE can derive the transmission direction of flexible subframe according to DL or UL assignment, actual configuration can be derived if there is corresponding DL or UL assignment in every flexible subframe. If the actual configuration is successfully obtained, PUCCH resource shall be implicitly determined by CCE index and a derived DL association set. The derived DL association set is based on the actual configuration and is a subset of DL association set of DL-reference configuration. If a DL association index is associated with a DL subframe under the actual configuration, the DL association index shall be included in the derived DL association set. Otherwise, the DL association index is not included. If the derived DL association set may cause PUCCH resource collision between eIMTA UE and legacy UE, re-ordering DL association index and/or adding virtual index shall be used to further modify the derived DL association set as described in solution 1. PUCCH resource shall be implicitly determined according to the finally derived DL association set. In this solution, the number of implicitly reserved PUCCH resource can be reduced as the number of actual DL subframe is less than that under DL-reference configuration. If the actual configuration is not successfully obtained, e.g. CRC check is not passed or there is no any DL or UL assignment in some flexible subframe, PUCCH shall be dropped.

Embodiment #5: When an eIMTA UE follows a DL-reference configuration different from System configuration and uses PUCCH format 1/1a/1b/1b with CS to feedback DL HARQ-ACK, the eIMTA UE shall implicitly determine PUCCH resource according to a derived DL association set index based on the actual configuration. Assuming System configuration is 0 and DL-reference configuration is 5, candidate actual configurations are 0˜6. If the actual configuration can be successfully obtained via explicit signaling or implicit derivation based on UL/DL assignment, the PUCCH resource shall be implicitly determined by CCE index and a derived DL association set as showed in table 13. If the actual configuration is the same as DL-reference configuration, DL association index set of actual configuration can be reused. If the actual configuration cannot be successfully obtained, PUCCH shall be dropped.

TABLE 13
Derived Downlink association set K′: {k₀′, k₁′, . . . k_{M-1}′}

| Actual | | Subframe n | | | | | | | | | |
|---|---|---|---|---|---|---|---|---|---|---|---|
| Configuration | 0 | 1 | 2 | | 3 | 4 | 5 | 6 | 7 | 8 | 9 |
| 0 | — | — | 13, 12, 9, 8, | 6, 12, 7, 11 | — | — | — | — | — | — | — |
| | | | 7, 5, 4, 11, | | | | | | | | |
| | | | 6→ | | | | | | | | |
| 1 | — | — | 13, 12, 9, 8, | 6, 13, 12, 8, | — | — | — | — | — | — | — |
| | | | 7, 5, 4, 11, | 7, 11 | | | | | | | |
| | | | 6→ | | | | | | | | |
| 2 | — | — | 13, 12, 9, 8, | 6, 13, 12, 9, | — | — | — | — | — | — | — |
| | | | 7, 5, 4, 11, | 8, 7, 4, 11 | | | | | | | |
| | | | 6→ | | | | | | | | |
| 3 | — | — | 13, 12, 9, 8, | 6, 13, 12, 7, | — | — | — | — | — | — | — |
| | | | 7, 5, 4, 11, | 5, 4, 11 | | | | | | | |
| | | | 6→ | | | | | | | | |
| 4 | — | — | 13, 12, 9, 8, | 6, 13, 12, 8, | — | — | — | — | — | — | — |
| | | | 7, 5, 4, 11, | 7, 5, 4, 11 | | | | | | | |
| | | | 6→ | | | | | | | | |
| 5 | — | — | 13, 12, 9, 8, | | — | — | — | — | — | — | — |
| | | | 7, 5, 4, 11, | | | | | | | | |
| | | | 6 | | | | | | | | |
| 6 | — | — | 13, 12, 9, 8, | 6, 13, 12, 7, | — | — | — | — | — | — | — |
| | | | 7, 5, 4, 11, | 11 | | | | | | | |
| | | | 6→ | | | | | | | | |

Section 2: PRACH Resource Allocation of eIMTA UE

Solution 1: PRACH Resource is Determined by PRACH Configuration Index under System Configuration.

For legacy UE, PRACH resource is determined by PRACH configuration index under System configuration. Since legacy UE always considers flexible subframe(s) with UL transmission direction, legacy UE may transmit PRACH in a flexible subframe where actual transmission direction may happen to be DL. The PRACH will cause intra-cell cross-link interference and cannot be detected. Accordingly, time consumption used for successful random access procedure will get much more. The network can avoid this issue by configuring proper PRACH configuration index, i.e. restricting PRACH resource only in fixed UL subframe or UpPTS. But only partial PRACH configuration index with PRACH preamble format 4 can meet this requirement, i.e. PRACH configuration index 48, 49 and 51. If there is no legacy UE or a relatively small number of legacy UEs in a network, this requirement is not suitable. So it is possible there is PRACH resource in flexible subframe if PRACH resource is determined by PRACH configuration index under System configuration.

In this solution, PRACH resource of eIMTA UE is determined by PRACH configuration index under System configuration, regardless of the PRACH is triggered by UE or eNB. In order to avoid intra-cell cross-link interference caused by PRACH in flexible subframe, only PRACH resource in available UL subframe or UpPTS is allowed to be used to transmit PRACH. If there is PRACH resource in a flexible subframe and UE knows actual transmission direction of the flexible subframe is uplink, PRACH can be transmitted in corresponding resource. If there is PRACH resource in a flexible subframe and UE knows actual transmission direction of the flexible subframe is downlink or UE doesn't know actual transmission direction of the flexible subframe, PRACH cannot be transmitted in corresponding resource. So the number of available PRACH resources is much less than that in non-adaptive TDD systems. This may increase the probability of PRACH preamble collision.

Solution 2: PRACH Resource is Determined by PRACH Configuration Index Under DL-Reference Configuration.

In this solution, PRACH resource of eIMTA UE is determined by PRACH configuration index under DL-reference configuration. In order to restrict PRACH resource only in fixed UL subframe or UpPTS, it is a straightforward method to determine PRACH resource according to PRACH configuration index under DL-reference configuration as all UL subframe(s) under DL-reference configuration are fixed. However, PRACH configuration index indicated in SIB 2 shall be ensured to be valid under both System configuration and DL-reference configuration as not all PRACH configuration index is valid under every UL-DL configuration. Comparing with solution 3, the number of available PRACH resources of eIMTA is much more the same to that in non-adaptive TDD systems. As legacy UE and eIMTA UE respectively follow System configuration and DL-reference configuration to determine PRACH resource, the number of total PRACH resource may be larger than that in non-adaptive systems if there is PRACH resource in flexible subframe according to System configuration. In addition, DL-reference configuration shall be explicitly signaled via dedicated signaling or implicitly derived according to candidate actual configurations before UE initiates random access.

Solution 3: PRACH Resource is Determined by PRACH Configuration Index Under Actual Configuration if the PRACH is Triggered by eNB via PDCCH Order Signaling.

In this solution, if PRACH is triggered by UE or by eNB via RRC signaling, PRACH resource is determined by PRACH configuration index under System configuration as described in solution 1 or DL-reference configuration as described in solution 2. If PRACH is triggered by eNB via PDCCH order signaling and the actual configuration is successfully obtained, PRACH is determined by PRACH configuration index under the actual configuration, thus additional PRACH resource can be exploited in flexible subframe. As configuration followed by resource allocation of PRACH triggered by eNB is different from that of PRACH triggered by UE, the number of total PRACH resource is larger than that in non-adaptive systems. If the actual configuration is updated during the PRACH procedure, all PRACH resources based on old configuration are disabled and the PRACH procedure is early terminated, or only PRACH resources in available UL subframe or UpPTS under new configuration can be used, or PRACH resource are updated according to new configuration. If PRACH is triggered by eNB via PDCCH order signaling and the actual configuration is not successfully obtained, the PRACH request shall not be responded, i.e. no PRACH is transmitted, or the PRACH request shall be responded with contention-based PRACH mechanism, i.e. similar to PRACH triggered by UE. In order to ensure that the actual configuration can be successfully obtained, the actual configuration can be indicated using several reserved bits in corresponding PDCCH order signaling (i.e. DCI format 1A) as there are multiple reserved bits in DCI format 1A in current specification.

Methods of physical resource allocation for UL control channels including PUCCH and PRACH in adaptive TDD systems are proposed in the embodiments of this invention. To resolve the problem of PUCCH resource collision between legacy UE following System configuration and eIMTA UE following DL-reference configuration which is different from System configuration, five solutions are proposed. In solution 1, PUCCH resource of eIMTA UE shall be implicitly determined by CCE index and modified DL association set of DL-reference configuration. Re-ordering association index and/or adding virtual index can be used to modify DL association set in some UL subframe(s) where PUCCH resource collision may happen. In solution 2, PUCCH resource of eIMTA UE shall be explicitly allocated. Multiple PUCCH resources values shall be configured by higher layers and one of these resources is dynamically selected via PHY signaling, e.g. TPC command for PUCCH in PDCCH assignment or HARQ-ACK resource offset in EPDCCH assignment. In solution 3 and 4, partially implicit and partially explicit resource allocation is used for PUCCH of eIMTA UE and dependent on adjacent corresponding DL association index. In solution 3, if the order of the adjacent corresponding DL association index in DL association set of DL-reference configuration is less than the size of the DL association set of System configuration, PUCCH resource shall be explicitly configured by higher layers. Otherwise, PUCCH resource is determined by CCE index and DL association set of DL-reference configuration. In solution 4, if the adjacent corresponding DL association index is included in DL association set of System configuration, PUCCH resource shall be explicitly configured by higher layers. Otherwise, PUCCH resource is determined by CCE index and DL association set of System configuration. In solution 5, PUCCH resource of eIMTA UE shall be implicitly determined by CCE index and a DL association set derived based on DL-reference configuration. If the actual configuration is not successfully obtained, PUCCH is dropped.

For PRACH resource allocation of eIMTA UE in adaptive TDD systems, three solutions are proposed. In solution 1, PRACH resource shall be determined by PRACH configuration index under System configuration, and only PRACH resource in available UL subframe or UpPTS can be used. In solution 2, PRACH resource shall be determined by PRACH configuration index under DL-reference configuration, thus PRACH can be transmitted only in fixed UL subframe or UpPTS of the first special subframe. In solution 3, if PRACH is triggered by UE or is triggered by eNB via RRC signaling, PRACH resource shall be determined by PRACH configuration index under System configuration or DL-reference configuration. If PRACH is triggered by eNB via PDCCH order signaling, PRACH resource shall be determined by PRACH configuration index under the actual configuration. If configuration is updated, PRACH procedure is early terminated, or only available PRACH resource in updated configuration can be used, or updated PRACH resource is determined by PRACH configuration index under updated configuration. If the actual configuration is not successfully obtained, PRACH is dropped or transmitted with contention-based mechanism similar to PRACH triggered by UE.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

1. A method for a UE to determine a PUCCH assignment for HARQ-ACK transmission in an adaptive TDD downlink-uplink configuration network, the method comprising:
obtaining a first DL-UL configuration;
obtaining a second DL-UL configuration different from the first DL-UL configuration; and
determining the PUCCH assignment based on at least the second DL-UL configuration wherein, at a subframe with PUCCH assignment, the downlink association set corresponding to the first DL-UL configuration is a subset of the downlink association set corresponding to the second DL-UL configuration.

2. The method of claim 1, wherein obtaining a first DL-UL configuration further comprising:
obtaining the first DL-UL configuration from SIB1.

3. The method of claim 1, wherein obtaining a second DL-UL configuration different from the first DL-UL configuration further comprising:
obtaining the second DL-UL configuration from dedicated signaling and using it as reference configuration for DL HARQ-ACK operation.

4. The method of claim 1, wherein the downlink association set corresponding to the first DL-UL configuration is a subset of the downlink association set corresponding to the second DL-UL configuration further comprising:
the downlink association set corresponding to the first DL-UL configuration is kept in the same order as a subset of the downlink association set corresponding to the second DL-UL configuration.

5. The method of claim 1, wherein determining the PUCCH assignment based on at least the second DL-UL configuration further comprising:
determining the PUCCH assignment additionally based on the first DL-UL configuration and CCE index used for transmission of adjacent corresponding PDCCH/EPDCCH assignment.

6. The method of claim 1, wherein determining the PUCCH assignment based on at least the second DL-UL configuration further comprising:
determining the PUCCH assignment additionally based on the first DL-UL configuration and high-layer signaling.

7. The method of claim 1, wherein determining the PUCCH assignment based on at least the second DL-UL configuration further comprising further comprising:
judging adjacent corresponding DL association index to determine the PUCCH assignment.

8. The method of claim 7, wherein judging adjacent corresponding DL association index to determine the PUCCH assignment further comprising:
if the DL association index is included in the DL association set corresponding to the first DL-UL configuration, determining the PUCCH assignment based on CCE index used for transmission of adjacent corresponding PDCCH/EPDCCH assignment and the DL association set corresponding to the first DL-UL configuration, otherwise, determining the PUCCH assignment based on high-layer signaling.

9. The method of claim 7, wherein judging adjacent corresponding DL association index to determine the PUCCH assignment further comprising:
if the order of the DL association index in the DL association set corresponding to the second DL-UL configuration is less than the size of the DL association set corresponding to the first DL-UL configuration, determining the PUCCH assignment based on high-layer signaling, otherwise, determining the PUCCH assignment based on CCE index used for transmission of adjacent corresponding PDCCH/EPDCCH assignment and the DL association set corresponding to the second DL-UL configuration.

10. The method of claim 1, wherein determining the PUCCH assignment based on at least the second DL-UL configuration further comprising:
obtaining a third DL-UL configuration which indicates actual transmission direction of every subframe and using the third configuration to obtain actual DL subframe set in the DL association set corresponding to the second DL-UL configuration; and
determining the PUCCH assignment additionally based on the actual DL subframe set, the fist DL-UL configuration and CCE index used for transmission of adjacent corresponding PDCCH/EPDCCH assignment.

11. The method of claim 10, wherein determining the PUCCH assignment additionally based on the actual DL subframe set, the fist DL-UL configuration and CCE index used for transmission of adjacent corresponding PDCCH/EPDCCH assignment further comprising:
determining the PUCCH assignment based on the CCE index and narrow downed DL association index set only including the actual DL subframe set wherein, the DL association set corresponding to the first DL-UL configuration is kept in the same order as a subset of the narrow downed DL association set corresponding to the second DL-UL configuration.

12. A method for a UE to determine PRACH assignment in an adaptive TDD downlink-uplink configuration network, the method comprising:
obtaining a system DL-UL configuration from SIB1;
obtaining an actual DL-UL configuration from dedicated signaling;
determining PRACH assignment according to PRACH configuration index under the first DL-UL fist configuration; and
judging whether PRACH resource is available based on the actual DL-UL configuration.

13. The method of claim 12, wherein judging whether PRACH resource is available based on the actual DL-UL configuration further comprising:
if there is PRACH resource in a flexible subframe and the UE obtain the actual transmission direction of the flexible subframe as uplink, corresponding PRACH resource is used to transmit PRACH; and
if there is PRACH resource in flexible subframe and the UE obtain the actual transmission direction of the flexible subframe as downlink or the UE does not obtain actual transmission direction of the flexible subframe, corresponding PRACH resource is not used to transmit PRACH.

14. A method for a UE to determine PRACH assignment in an adaptive TDD downlink-uplink configuration network, the method comprising:
obtaining a DL-UL configuration which is with the least schedulable UL subframe and is used as reference configuration for DL HARQ-ACK operation; and
determining PRACH assignment according to PRACH configuration index and the DL-UL configuration.
